(19) United States
(12) Patent Application Publication
(10) Pub. No.: US 2017/0238582 A1
(43) Pub. Date: Aug. 24, 2017

(54) Method of Preparing Cannabis-Infused Alcoholic Beverage

(71) Applicant: Lewis Garnett, Richmond, VA (US)

(72) Inventor: Lewis Garnett, Richmond, VA (US)

(21) Appl. No.: 15/439,635

(22) Filed: Feb. 22, 2017

Related U.S. Application Data
(60) Provisional application No. 62/298,003, filed on Feb. 22, 2016.

(51) Int. Cl. A23L 2/52; A23L 2/38

(52) U.S. Cl. CPC A23L 2/52; A23L 2/382; A23V 2002/00

(57) ABSTRACT

A method of preparing a cannabis-infused alcoholic beverage. The method includes separating the stems, seeds, and stalks of a cannabis plant, grinding them into a powder, mixing the powder with water, heating the mixture and adding amylase enzyme. After stirring, the mixture is cooled and combined with yeast, sugar, water, and flavoring, forming a precursor mixture. The precursor mixture is fermented in a fermenter, and then strained, resulting in a first product, which is an alcoholic beverage called Mareer. Straining the Mareer twice through three layers of cheesecloth results in a second product called Meer. Distilling the Meer results in a third product called Mariquor. The method allows typically discarded portions of the cannabis plant to be utilized and the maximum amount of cannabinoids extracted therefrom.

### CROSS REFERENCE TO RELATED APPLICATIONS

This application claims the benefit of U.S. Provisional Application No. 62/298,003 filed on Feb. 22, 2016. The above identified patent application is herein incorporated by reference in its entirety to provide continuity of disclosure.

### FIELD OF THE INVENTION

The present invention relates to methods of preparing cannabis-infused beverages. More particularly, the present invention provides a method of preparing a cannabis-infused alcoholic beverage that utilizes the stems, stalks, seeds, and other parts of the cannabis plant that would normally be discarded.

### BACKGROUND OF THE INVENTION

Many individuals consume marijuana for recreational or medicinal purposes. The main active compounds found in marijuana are called cannabinoids, which act on cannabinoid receptors in cells that repress neurotransmitter release in the brain. Cannabinoids have been shown to provide benefits such as reduced anxiety, increased healing properties, and the like.

Cannabinoids are consumed using a variety of methods, including inhalation of combusting cannabis plant materials or inhalation of vaporized plant material. The consumption of cannabinoids by inhalation has many disadvantages, including damage to the respiratory system due to inhalation of harmful byproducts caused by the combustion process. Additionally, the residual smell burned cannabis plant material is undesirable to many. Further, it can be difficult to provide a particular dose of cannabinoids when smoking or vaporizing the plant material. It is desirable to provide a method for preparing a cannabis-infused alcoholic beverage that allows individuals to consume cannabinoids in a manner other than smoking or vaporizing.

When combusting the cannabis plant to obtain cannabinoids, only the leaf and flower of the plant are typically utilized, because combusting other parts of the plant releases very little cannabinoids and undesirable byproducts such as carbon monoxide and carbon dioxide. As such, the rest of the cannabis plant, such as the stems, stalks, and seeds, are typically discarded. However, the stems, stalks, and seeds still contain cannabinoids that may be consumed if properly extracted. Therefore, the present invention provides a method for preparing a cannabis-infused alcoholic beverage that utilizes the stems, stalks, and seeds as a starting material.

### SUMMARY OF THE INVENTION

In view of the foregoing disadvantages inherent in the known types of methods for producing cannabis-infused beverages now present in the prior art, the present invention provides a method for producing a cannabis-infused alcoholic beverage wherein the same can be utilized for providing convenience for the user when using the stems, seeds, stalks, and other typically undesirable parts of the cannabis plant. The present method includes the steps of: separating a plurality of stems, a plurality of seeds, and a plurality of stalks from one or more cannabis plants; grinding the plurality of stems, the plurality of seeds, and the plurality of stalks to form a powder; mixing the powder with water to form a cannabis mixture; heating the cannabis mixture to 150 degrees Fahrenheit; adding an amount of amylase enzyme to the cannabis mixture; stirring the cannabis mixture in increments of five minutes for a thirty minute period; reducing the temperature of the cannabis mixture to less than 95 degrees Fahrenheit; combining an amount of yeast, an amount of sugar, an amount of water, and the cannabis mixture to form a precursor mixture; fermenting the precursor mixture in a fermenter to form a first product; and straining the first product.

One object of the present invention is to provide a method of making a cannabis-infused alcoholic beverage that utilizes the stems, seeds, and stalks of the cannabis plant.

Other objects, features, and advantages of the present invention will become apparent from the following detailed description taken in conjunction with the accompanying drawings

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart of the method for preparing a cannabis-infused alcoholic beverage.

### DETAILED DESCRIPTION OF THE INVENTION

Reference is made herein to the attached drawings. Like reference numerals are used throughout the drawings to depict like or similar elements of the present invention. For the purposes of presenting a brief and clear description of the present invention, the preferred embodiment will be discussed as used for preparing a cannabis-infused alcoholic beverage. The figures are intended for representative purposes only and should not be considered to be limiting in any respect.

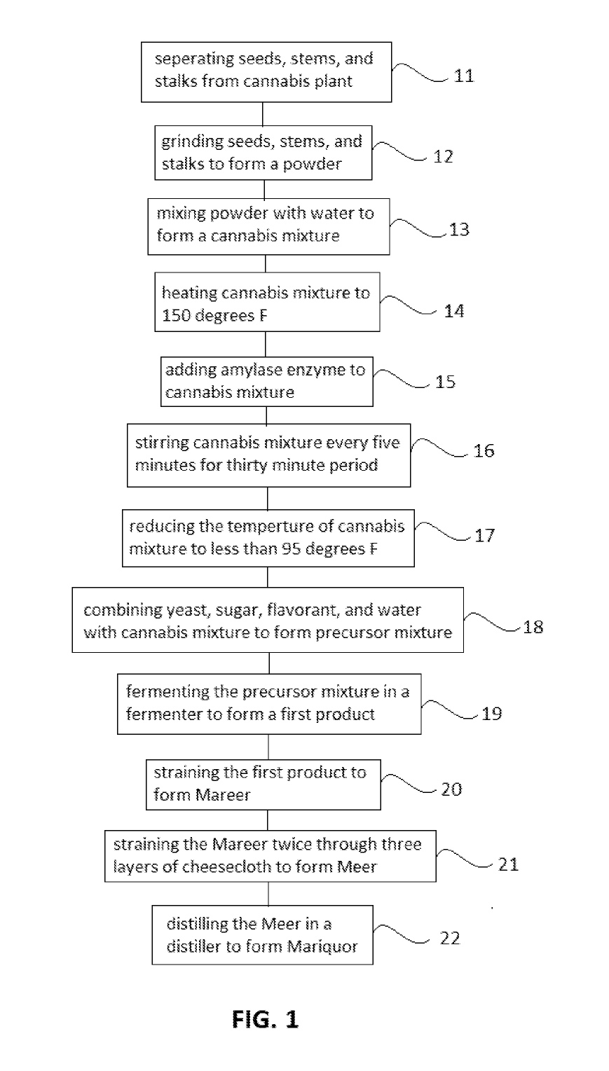

Referring now to FIG. 1, there is shown a flowchart of the method for preparing a cannabis-infused alcoholic beverage. The first step includes separating the seeds, stems, and stalks of the cannabis plant 11. Typically, this portion of the plant remains after the flowers and leaves have been removed. While the seeds, stems, and stalks are normally discarded, they still contain cannabinoids that may be consumed, and as such may be processed into an alcoholic beverage according to the present method.

A next step in the method includes grinding the seeds, stems, and stalks to form a powder 12. In one embodiment of the invention, one pound of seeds, stems, and stalks is utilized. The next step involves mixing the resulting powder with water to form a cannabis mixture 13. In one embodiment, one pound of powder is mixed with two gallons of water. In the next step, the cannabis mixture is heated to 150 degrees Fahrenheit (F). The temperature should not be increased beyond 150 degrees F. It is important to note that overheating of the cannabis can result in less product yield. This is because a high heat will cause the cannabinoids to volatilize and dissipate before they can be infused into the resulting beverage.

A next step in the method includes adding amylase enzyme to the cannabis mixture 15. In one embodiment, a tablespoon of amylase enzyme is utilized. Next, the cannabis mixture is stirred once every five minutes for a thirty minute duration 16. This step helps dissolve and activate the amylase enzyme. Then, the temperature of the cannabis mixture is reduced to 95 degrees F. or less 17 prior to the next steps.

The next step involves combining yeast, sugar, flavoring, and water with the cannabis mixture to form a precursor mixture 18. The flavoring may be dried fruit, grains, herbs, or any other item typically utilized to impart flavor during a fermentation or brewing process. In one embodiment, five pounds of sugar and two tablespoons of yeast are utilized. The precursor mixture is then placed in a fermenter. The fermenter may be any device typically utilized for fermenting a mixture of water, yeast, sugar, and other ingredients to form an alcoholic beverage, which is created as a byproduct of the yeast digesting the sugar in the mixture. The precursor mixture is fermented for at least seven days and for up to ten days 19 to form a first product. The first product is then strained 20, resulting in a product referred to as Mareer.

The product can be further refined to produce different types of beverages of varying potency. In an additional step, the Mareer is strained twice through three layers of cheesecloth 21, which results in a further refined product referred to as Meer. For additional refinement, the Meer may be distilled in a distiller 22, which results in a yet further refined product referred to as Mariquor. The distiller may be any typical distiller used to distill an alcoholic beverage, which is well known in the art.

The resulting product, whether it be the Mareer, the refined Meer, or the distilled Mariquor, may be consumed by an individual in order to consume both alcohol and cannabinoids. The alcohol content of the final product varies according to the composition of the precursor mixture, the fermentation time, and the distilling time. In this way, individuals may determine the potency of the product via experimentation with ingredient times and amounts; however, the method for producing the product remains the same.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of making a cannabis-infused beverage comprising:
separating a plurality of stems, a plurality of seeds, and a plurality of stalks from one or more cannabis plants;
grinding the plurality of stems, the plurality of seeds, and the plurality of stalks to form a powder;
mixing the powder with water to form a cannabis mixture;
heating the cannabis mixture to 150 degrees F.;
adding an amount of amylase enzyme to the cannabis mixture;
stirring the cannabis mixture in increments of five minutes for a thirty minute period;
reducing the temperature of the cannabis mixture to a temperature equal to or less than 95 degrees F.;
combining an amount of yeast, an amount of sugar, an amount of water, and the cannabis mixture to form a precursor mixture;
fermenting the precursor mixture in a fermenter to form a first product; and
straining the first product with a first strainer.

2) The method of claim 1, wherein powder is composed of one pound of the plurality of stems, plurality of seeds, and plurality of stalks.

3) The method of claim 1, wherein the amount of amylase enzyme is one tablespoon.

4) The method of claim 1, wherein the fermenting step further comprises leaving the precursor mixture in the fermenter for at least even days.

5) The method of claim 1, wherein the amount of yeast comprises two tablespoons, the amount of sugar comprises five pounds, and the amount of water comprise two gallons.

6) The method of claim 1, further comprising:
straining the first product through a second strainer twice to form a second product, wherein the second strainer comprises at least three layers of cheesecloth.

7) The method of claim 6, further comprising
adding the second product to a distiller;
distilling the second product to form a third product.
